(19) United States
(12) Patent Application Publication
(10) Pub. No.: US 2007/0035179 A1
(43) Pub. Date: Feb. 15, 2007

(54) Device and method for identifying hydraulic defects in electrohydraulic brake system

(75) Inventors: Wolfgang Kling, Kelkheim (DE); Rudiger Puff, Hunstetten-Wallbach (DE)

Correspondence Address: Gerlinde M Nattler;Craig Hallacher, Continental Teves, One Continental Drive, Auburn Hills, MI, 48326, US

(73) Assignee: Continental Teves AG & Co. oHG

(21) Appl. No.: 10/564,006

(22) PCT Filed: Jul. 8, 2004
(86) PCT No.: PCT/EP04/51419

§ 371 Date: Jul. 3, 2006

(30) Foreign Application Priority Data
Jul. 8, 2003 (DE) 10330664.1

(51) Int. Cl. B60T 8/88

(52) U.S. Cl. 303/122.09

(57) ABSTRACT

Disclosed is a method for identifying hydraulic defects in electrohydraulic brake systems for motor vehicles including an electronic regulation and control unit, wheel brakes equipped with inlet and outlet valves, and at least one pressure source. Further disclosed is a device for implementing the method of the invention. According to the disclosed method, the individual causing defect is localized after a defect pattern is identified in order to operate the brake system in an operating mode which takes into account the individual causing defect.

### BACKGROUND OF THE INVENTION

The present invention relates to a method for identifying hydraulic defects in electrohydraulic brake systems for motor vehicles including an electronic regulation and control unit, wheel brakes equipped with inlet and outlet valves, and at least one pressure source. Further, the invention relates to a device for implementing the method of the invention.

In electrohydraulic brake systems known in the art, an operating mode is directly selected when a defect pattern appears, which mode takes into account all possible individual defects which cause a common defect pattern. Thus, an operating mode is chosen which deactivates a major part of the brake system when a defect pattern appears or disables control functions of the brake system and, consequently, provides the operator with a brake system that is partly limited to a considerable extent.

### SUMMARY OF THE INVENTION

In view of the above, an object of the invention is to disclose a method of identifying hydraulic defects which provides the operator with a brake system satisfying major safety and comfort aspects.

According to the invention, this object is achieved by the following process steps:
Identification of a defect pattern by comparing several hydraulic and electric nominal values with the actual values measured by sensors in the electronic regulation and control unit;
Selection of a testing routine which corresponds to the defect pattern and execution thereof;
Localization of the individual defect causing the defect pattern;
Selection of an operating mode which takes into account the individual causing defect and operation of the brake system in this operating mode.

According to a favorable embodiment of the method of the invention, different priorities are assigned to the defect patterns, and a coordinated termination of the momentarily performed testing routine is arranged for when a defect pattern with a higher priority appears.

To render the idea of the invention more precise, provisions are made to ensure a coordinated termination of the momentarily performed testing routine in the event of an interaction of the operator. As this occurs, the coordinated termination is performed by making the brake system adopt the same condition as before the commencement of the testing routine that is to be stopped.

In another favorable improvement of the method of the invention, the testing routine checks the hydraulic components in terms of their operability which are associated with a defect pattern, or modifies control strategies in order to find the individual causing defect.

It is furthermore provided that the testing routines run without being noticed by the operator and maintain the maximum braking power, or are alternatively performed when the motor vehicle is in a condition in which the effects of the testing routines performed will not induce any dangerous driving situation.

After the successful localization of the individual causing defect additional, newly identified defect patterns are processed, and a limited quantity of individual defects will be taken into account by an operating mode after an abortive localization of the individual causing defect until an appropriate testing situation is available to localize the individual causing defect.

The brake system of the invention for implementing the above-mentioned method is characterized in that
Means are provided to identify a defect pattern by comparing several hydraulic and electric nominal values with the actual values measured by the sensors in the electronic regulation and control unit, and that;
Additional means are provided for the selection of a testing routine which corresponds to the defect pattern and execution thereof, and that;
Additional means are provided for the localization of the individual defect causing the defect pattern, and that;
Additional means are provided for the selection of an operating mode which takes into account the individual causing defect, and for the operation of the brake system in this operating mode.

In a particularly favorable design, additional means are provided which assign different priorities to the defect patterns and perform a coordinated termination of the momentarily performed testing routine when a defect pattern with a higher priority appears. In this arrangement, the means perform the coordinated termination by making the brake system adopt the same condition as before the commencement of the testing routine that is to be stopped.

In another favorable embodiment, the means perform active tests in the brake system or modify control strategies in order to find the individual causing defect.

### BRIEF DESCRIPTION OF THE DRAWINGS

The invention will be explained in detail in the following by making reference to the accompanying drawings. In the drawings:

FIG. 1 shows a schematic circuit diagram of an electrohydraulic brake system allowing implementation of the method of the invention, and

FIG. 2 shows the method of the invention in a schematic view of a flow chart.

### DETAILED DESCRIPTION OF THE DRAWINGS

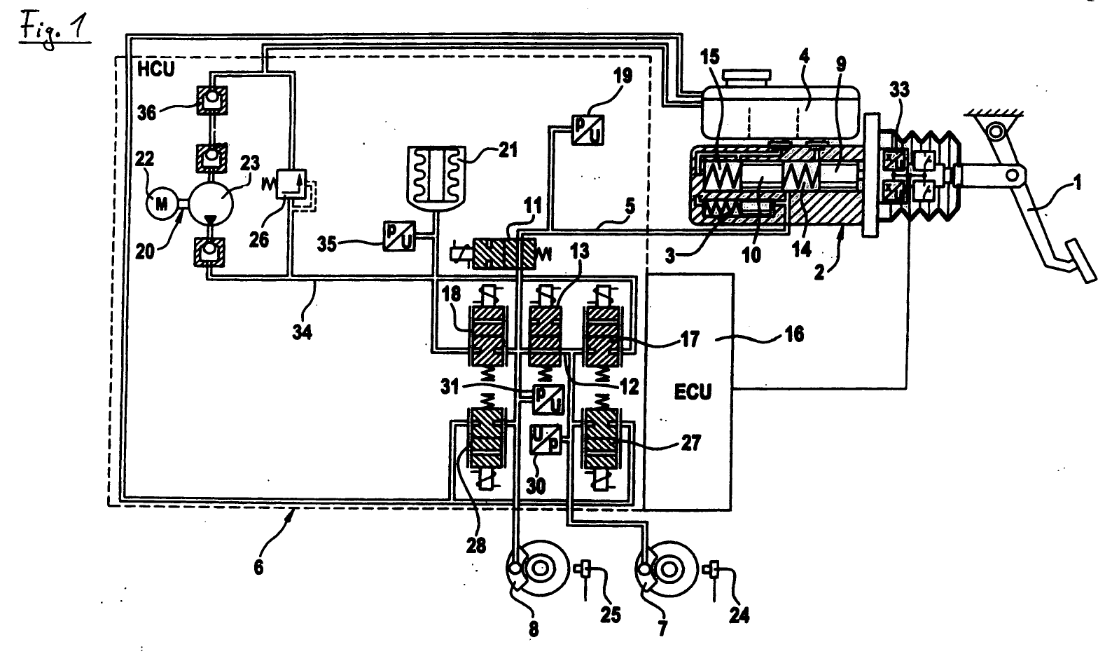

The brake system which is only represented in FIG. 1 is essentially composed of a dual-circuit hydraulic pressure generator or master brake cylinder 2 in a tandem design which is operable by means of a brake pedal 1, a travel simulator 3 cooperating with the tandem master cylinder 2, a pressure fluid supply reservoir 4 associated with the tandem master cylinder 2, a hydraulic pressure source, a control unit HCU 6 which is only represented and comprises, among others, all components necessary for pressure control operations and to which e.g. wheel brakes 7, 8 are connected that are associated with the rear axle of the motor vehicle, as well as an electronic regulation and control unit ECU 16. Wheel sensors 24, 25 (only indicated) are used to determine the rotational speed of the vehicle wheels. The per se known tandem master cylinder 2 includes two isolated pressure chambers 14, 15 which are limited by two pistons 9, 10 and are connectable both to the pressure fluid supply reservoir 4 and, through the HCU 6, also to the vehicle brakes 7, 8, -, -. The above-mentioned pressure source is formed of a motor-and-pump assembly 20 which is composed of an electric motor 22 and a pump 23 driven by the electric motor 22, a pressure-limiting valve 26 that is connected in parallel to the pump 23, and a high-pressure accumulator 21 which can be charged by means of pump 23 and the media-separating element of which is a metal pleated bellows. Further, the high-pressure accumulator 21 includes a travel sensor (not shown) for detecting the position of the metal pleated bellows, what allows determining the pressure fluid volume stored in the high-pressure accumulator 21. A pressure sensor 35 monitors the hydraulic pressure provided by the high-pressure accumulator 21.

As can further be taken from the drawings, the wheel brakes 7, 8 are connected to the first pressure chamber 14 by means of a conduit 5 in which a separating valve 11 is inserted which is configured as a normally open (NO) two-way/two-position directional control valve and permits closing the first pressure chamber 14. A second hydraulic conduit 34 connects the pressure side of the pump 23 or the high-pressure accumulator 21 to the inlet connections of two electromagnetically operable, preferably normally closed (NC) two-way/two-position directional control valves of analog operation or inlet valves 17, 18, respectively, which are connected upstream of the wheel brakes 7 and 8. Another pair of likewise electromagnetically operable, preferably normally closed (NC) two-way/two-position directional control valves of analog operation or outlet valves 27, 28, respectively, allow a connection between the wheel brake 7, 8 and the pressure fluid supply reservoir 4, while an electromagnetically operable, preferably normally open (NO) pressure compensating valve 13 allows a wheel-individual control of the pressures introduced into the wheel brakes 7, 8.

Further, pressure sensors 30, 31 are associated with the wheel brakes 7, 8 and used to determine the hydraulic pressure that prevails in the wheel brakes 7, 8. The above-mentioned electronic control and regulation unit ECU 16 to which are sent the output signals of the pressure sensors 19, 30, 31, 35, of the wheel speed sensors 24, 25, and of a preferably redundantly designed brake request detection device 33, which latter is associated with the master brake cylinder 2, is used to actuate the motor-and-pump assembly 20 and the above-mentioned valves 11, 13, 17, 18, 27, 28.

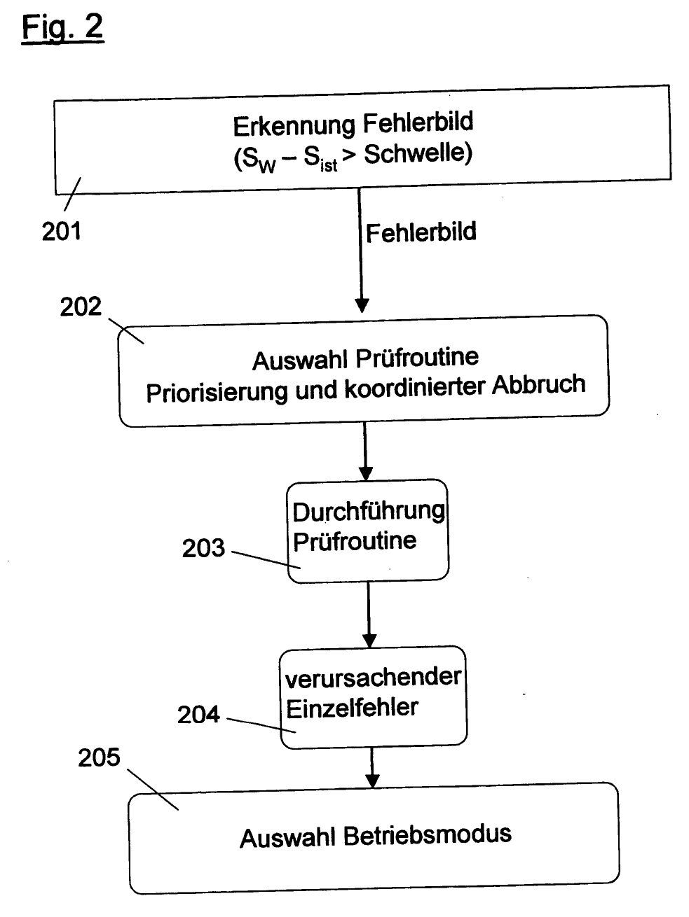

The method of the invention will be explained in detail in the following by way of the schematic flow chart illustrated in FIG. 2. The method of the invention can be implemented both in an electrohydraulic brake system of the type ‘brake-by-wire’ as described by way of FIG. 1 and in a conventional electrohydraulic brake system.

The method of the invention arranges that initially a defect pattern is identified in the electronic regulation and control unit mentioned by way of FIG. 1 (process step 201). To this end, all hydraulic and electric nominal values are compared continuously with the measured actual values during the operation of the brake system by producing the difference between the two values. A defect pattern prevails in case the amount of the difference exceeds a previously defined threshold. The expression ‘defect pattern’ is above all used because the previously mentioned deviation of the measured actual values from the nominal values can have different causes of defects, the so-called individual causing defects. This means that by way of the deviation from nominal values, a defined defect pattern is obtained which can have its origin in different individual defects. It is the objective of the method of the invention to localize the individual defect which causes the defect pattern in order to select an operating mode for the brake system which takes into account the individual causing defect.

After a defect pattern has been identified in the process step 201 of the flow chart illustrated in FIG. 2, a priority is assigned to the defect pattern which corresponds to the relevance of the defect pattern with respect to the safety of operation of the brake system (process step 202). Subsequently, a testing routine corresponding to the defect pattern is selected and performed in the process step 203. The hydraulic components which might be defective according to the defect pattern are checked in terms of their operability. In addition, prevailing control strategies are modified in order to check the hydraulic components likewise in terms of their operability. It is arranged for that the testing routine and the change of the control strategies take place without being noticed by the operator and the maximum possible braking power is maintained. Therefore, the testing routine is e.g. performed preferably when the motor vehicle is in a condition in which the effects of the implementation cannot induce any dangerous driving situations, such as during a stop period of the motor vehicle. The testing routine and the amendment of the existing control strategies allow localizing the individual defect 204 which causes the defect pattern and selecting an operating mode for the brake system which takes the individual causing defect into account (process step 205).

After a successful localization of the individual causing defect and the operation of the brake system in an operating mode which takes into account the individual causing defect, the method of the invention can be executed again when a defect pattern is identified again. In this connection it is defined that the method of the invention is appropriate for multiple defects.

When the localization of the individual causing defect fails, the brake system will be operated in an operating mode which takes into account a limited quantity of individual defects that fit to the identified defect pattern. Localization of the individual causing defect will be caught up on when an appropriate testing situation prevails.

As has been described hereinabove, different priorities are assigned to each defect pattern identified in the process step 201, which correspond to the relevance of the defect pattern in terms of the safety of operation of the brake system. For the case that another defect pattern with a higher priority is identified during the above-mentioned implementation of the testing routine (process step 203), the momentarily performed testing routine is discontinued in a coordinated manner. This coordinated stop acts both on the momentarily performed testing routine and the modification of the prevailing control strategies and causes the brake system to adopt the same condition as before the commencement of the testing routine which shall be stopped in a coordinated manner. A master-slave structure is referred to in this context because the different testing routines (slaves) are administered and coordinated by a superior unit (master).

A coordinated stop of the momentarily performed testing routine is likewise intended in an interaction of the operator. For example, the testing routine must be stopped in a coordinated manner when it is performed during a stop period of the motor vehicle and the operator wishes to move his vehicle in an unbraked state again.

To specify the method of the invention, the method described hereinabove will be described in the following by way of a concrete defect pattern, reference being made to FIG. 1. When the inlet valves 17, 18 of the wheel brakes 7, 8 being configured as (NC) two-way/two-position directional control valves are not actuated, that means they are not opened, the pressure fluid volume in the high-pressure accumulator 21 must not decrease. The travel sensor, which has already been described and is not illustrated in FIG. 1, determines the position of the metal pleated bellows in the high-pressure accumulator 21 and, hence, also the pressure fluid volume stored therein. The travel sensor furnishes an actual value which is compared with the associated nominal value in the electronic regulation and control unit 16. Once the difference between the two values is higher than a previously fixed threshold, a defect pattern is identified with respect to the non-plausible evacuation of the high-pressure accumulator 21. The individual defect which is the possible cause for the non-plausible evacuation of the high-pressure accumulator 21 is leakage of the inlet valves 17, 18, leakage of the hydraulic conduit 34 or the high-pressure accumulator 21, or a defect of the just mentioned travel sensor. Further, the individual causing defect may also consist in that there is an inside leakage of the pump 23.

A testing routine that is appropriate for the defect pattern ‘non-plausible evacuation of the high-pressure accumulator 21’ is chosen in the following process step. This testing routine is started when no pressure build-up in the wheel brakes 7, 8 is requested. Subsequently, both the separating valve 11 and the pressure compensating valve 13 are closed, and the signals of the pressure sensors 30, 31 are monitored. The inlet and outlet valves 17, 18, 27, 28 of the wheel brakes 7, 8 are likewise closed. When the individual defect causing the defect pattern described above is a no more closing inlet valve 17 of the wheel brake 7, the pressure sensor 30 will output a signal with an actual pressure value which differs from the expected nominal value of 0 bar. Thus, the non-plausible evacuation of the accumulator is caused by the no longer functioning inlet valve 17. An operating mode which takes into consideration this individual causing defect provides that the pressure fluid is discharged from the high-pressure accumulator 21 and the pressure increase in the wheel brakes 7, 8 is executed exclusively by way of the pump 23. It is insignificant in this operating mode that the inlet valve 17 is defective.

In case that an actual pressure value differing from the expected nominal pressure value of 0 bar is not measured, the defect pattern must be caused by another individual defect. The testing routine now arranges for the accumulator volume of pressure fluid in the high-pressure accumulator 21 to be maintained close to a predetermined top threshold. In case the individual causing defect is a relatively great leakage of the hydraulic conduit 34 or the high-pressure accumulator 21, the pump 23 will not be in a position to replenish the high-pressure accumulator 21 what is sensed by the travel sensor in the high-pressure accumulator 21. The pump monitoring unit will report in this case that the high-pressure accumulator 21 is not being charged, although the pump 21 supplies a maximum of pressure fluid into the high-pressure accumulator 21. This message of the pump monitoring unit indicates great leakage of the hydraulic conduit 34 or the high-pressure accumulator 21. The operating mode which takes into account this individual causing defect is the prior art hydraulic fall-back mode, wherein the pressure increase in the wheel brakes 7, 8 takes place exclusively by way of displacement of the pistons 9, 10 in the master brake cylinder 2. In case the leakage of the hydraulic conduit 34 or the high-pressure accumulator 21 is not considerable, the pump 23 will charge the high-pressure accumulator 21 up to the predetermined top threshold. When the pump is in a position for a defined period of preferably 150 sec to maintain the pressure fluid volume in the high-pressure accumulator 21 above the top threshold mentioned before, the individual causing defect is an insignificant leakage of the hydraulic conduit 34 or an inner leakage of the motor-and-pump assembly 20. Which of the defects is exactly the individual causing defect cannot be decided until an alert notice indicating too low pressure fluid volume in the pressure fluid supply reservoir 4 appears. This fact concerns insignificant leakage of the hydraulic conduit 34 because in this case the pressure fluid is lost in the ambience, while the pressure fluid propagates back into the pressure fluid supply reservoir 4 in the event of an inner leakage of the pump 23. The operating mode which safeguards a reliable operation of the brake system will take into consideration both possible individual defects in this case, and it is the hydraulic fall-back mode again.

Another defect pattern which is identified in the process step 201 of the method of the invention is represented by the difference between an actual pressure value p_{actual} measured by one of the pressure sensors 19, 30, 31, 35 and a preset nominal pressure value pₙₒₘᵢₙₐₗ in at least one of the wheel brakes 7, 8, -, -. When the amount of the difference is higher than a predetermined threshold, the method of the invention will be started as has already been described. The possible individual causing defects and the pertinent testing routine can be seen accordingly in the defect pattern previously described.

In case the volume input of pressure fluid in a wheel brake 7, 8 which can be found out by the above-mentioned travel sensor in the high pressure accumulator 21, exceeds the volume input that is possible due to the constructive design of the wheel brake 7, 8, this condition in turn presents a defect pattern, the individual causing defect of which is localized by means of the method of the invention in order to operate the brake system in an operating mode which takes the individual causing defect into account.

In case the actual pressure value p_{actual} in the wheel brake 7 measured by the pressure sensor 30 or the actual pressure value p_{actual} in the wheel brake 8 measured by the pressure sensor 31 rises although a braking request of the driver is not detected by the braking request detection device 33, this fact concerns likewise a defect pattern, the individual causing defect of which is localized by means of the method described hereinabove.

In the event of a deviation of the measured performance under load of the motor-and-pump assembly 20 compared to the predetermined performance under load or in the event of an insufficient feed performance of the hydraulic motor-and-pump assembly 20, a defect pattern is likewise identified, and the individual causing defect is localized by the method of the invention by means of an appropriate testing routine.

The pressure in the master brake cylinder 2 which is measured by the pressure sensor 19 depends on the displacement travel of the piston 9. Because the above-mentioned piston 9 is displaced by the brake pedal 1, the movement of which is detected by the braking request detection device 33, a deviation of the actual pressure value in the master brake cylinder 2 compared to the nominal pressure value that is expected due to the measured displacement travel of the piston 9 represents a defect pattern. The individual defect causing this defect pattern is localized by the method described, and the brake system is operated in an operating mode which takes into account the individual causing defect.

1-18. (canceled)

19. A method for identifying hydraulic defects in electrohydraulic brake systems for motor vehicles including an electronic regulation and control unit, wheel brakes equipped with one or more inlet valves and outlet valves and at least one pressure source, the method comprising:
identifying a defect pattern by comparing several hydraulic and electric nominal values with actual values measured by sensors in an electronic regulation and control unit;
selecting a testing routine which corresponds to the defect pattern and execution thereof;
localizing one more individual defects causing the defect pattern; and
selecting an operating mode which takes into account the on ore more individual causing defects and operation of the brake system in this operating mode.

20. A method according to claim 19, wherein different priorities are assigned to the defect patterns, and in a coordinated termination of the performed testing routine is arranged for when a defect pattern with a higher priority appears.

21. The method according to claim 19, wherein a coordinated termination of the performed testing routine is arranged for in the event of an interaction of the operator.

22. The method according to claim 21, wherein the coordinated termination is performed by making the brake system adopt the same condition as before the commencement of the testing routine that is to be stopped.

23. The method according to claim 19, wherein the testing routine checks the hydraulic components which are associated with a defect pattern in terms of operability or modifies control strategies in order to find the individual causing defect.

24. The method according to claim 23, wherein the testing routines run without being noticed by the operator and maintain a maximum possible braking power, or are alternatively performed when the motor vehicle is in a condition in which the effects of the testing routines performed will not induce any dangerous driving situation.

25. The method according to claim 19, wherein after the successful localization of the individual causing defect, additional, newly identified defect patterns are processed.

26. The method according to claim 19, wherein after an abortive localization of the individual causing defect, a limited quantity of individual defects will be taken into account by an operating mode until an appropriate testing situation is available to localize the individual causing defect.

27. The method according to claim 19, wherein the defect pattern is represented by an actual pressure value (p_{actual}) measured by a pressure sensor (19, 30, 31, 35) and differing in at least one wheel brake (7, 8) from a preset nominal pressure value (pₙₒₘᵢₙₐₗ).

28. The method according to claim 19, wherein the defect pattern is represented by a volume input in at least one wheel brake (7, 8) which exceeds the volume input that is predetermined by the constructive design of the wheel brake (7, 8).

29. The method according to claim 19, the defect pattern is represented by a rising pressure value in at least one wheel brake (7, 8) in absence of a braking request of a driver.

30. The method according to claim 19, wherein the pressure source is a high-pressure accumulator (21), and the defect pattern is represented by a declining volume in the high-pressure accumulator (21), with the inlet valves (17, 18) being simultaneously closed.

31. The method according to claim 19, wherein the pressure source is a hydraulic motor-and-pump-assembly (20), and the defect pattern is represented by a deviation of the measured performance under load from the predetermined performance under load or by an insufficient feed performance of the hydraulic motor-and-pump assembly (20).

32. The method according to claim 19, wherein the pressure source is a master brake cylinder (2) with at least one piston (9, 10), and the defect pattern is represented by a deviation of the actual pressure value determined in the master brake cylinder compared to the nominal pressure value that is expected on account of the measured displacement travel of the piston (9).

33. An electrohydraulic brake system for a motor vehicle comprising:
an electronic regulation and control unit (16);
wheel brakes (7, 8) equipped with inlet valves (17, 18) and outlet valves (27, 28);
at least one pressure source;
a device to identify a defect pattern by comparing several hydraulic and electric nominal values with actual values measured by sensors in the electronic regulation and control unit (16);
a device for selecting a testing routine which corresponds to the defect pattern and execution thereof;
a device for localizing an individual defect causing the defect pattern; and
a device for selecting an operating mode which takes into account the individual causing defect, and for the operation of the brake system in this operating mode.

34. The device according to claim 33, wherein an additional device is provided which assigns different priorities to the defect patterns and perform a coordinated termination of the performed testing routine when a defect pattern with a higher priority appears.

35. The device according to claim 33, wherein the device for performing the coordinated termination by making the brake system adopt the same condition as before the commencement of the testing routine that is to be stopped.

36. The device according to claim 33, wherein active tests in the brake system are performed or control strategies are modified in order to find the individual causing defect.
